(19) United States
(12) Patent Application Publication
(10) Pub. No.: US 2019/0286881 A1
(43) Pub. Date: Sep. 19, 2019

(54) INFORMATION PROCESSING APPARATUS, A NON-TRANSITORY RECORDING MEDIUM, AND INFORMATION PROCESSING SYSTEM

(71) Applicant: Satoru HIRAKATA, Tokyo (JP)

(72) Inventor: Satoru HIRAKATA, Tokyo (JP)

(21) Appl. No.: 16/295,075

(22) Filed: Mar. 7, 2019

(30) Foreign Application Priority Data
Mar. 19, 2018 (JP) 2018-051438

(51) Int. Cl. G06K 9/00; G06K 9/22

(52) U.S. Cl. CPC G06K 9/00161; G06K 2209/01; G06K 9/22

(57) ABSTRACT

An information processing apparatus that includes at least one memory and circuitry. The circuitry acquires user information. The circuitry receives data including signature. The circuitry analyzes character strings of the signature included the data. The circuitry compares a result of analyzing the character strings of signature included the data with the acquired user information. In response to the result of comparing the character strings of signature included in the data with the acquired user information, the circuitry sends the data to a predetermined destination.

### CROSS-REFERENCE TO RELATED APPLICATIONS

This patent application is based on and claims priority pursuant to 35 U.S.C. § 119(a) to Japanese Patent Application No. 2018-051438 filed on Mar. 19, 2018, in the Japan Patent Office, the entire disclosure of which is hereby incorporated by reference herein.

### BACKGROUND

### Technical Field

The present invention relates to an information processing apparatus, a non-transitory recording medium and information processing system.

### Description of the Related Art

A national tax document of less than 30,000 yen can submitted electronically by revising the Enforcement Regulation of the Electric Ledger Storage Law in Japan. Furthermore, a document management server can automatically perform a predetermined process, when the document management server detects a file in a specific folder. The predetermined process is one of format conversion, print, and the like.

When a national tax document is submitted electronically, a device can perform OCR (Optional Character Recognition) process to the document including handwriting signature.

### SUMMARY

In an embodiment an information processing apparatus is provided that includes at least one memory; and circuitry configured to; acquire user information; receive data that includes a signature; analyze character strings of the signature included in the data; compare a result of analyzing the character strings of the signature included the data with the acquired user information; and in response to the result of comparing the character strings of the signature included in the data with the acquired user information, send the data to a predetermined destination.

In an embodiment, the character strings are analyzed by optional character recognition.

In an embodiment, the circuitry is further configured to, when the result of comparing the character strings of the signature indicate that the result of analyzing the character strings of the signature which is included the data and the acquired user information match, decide to send the data to the predetermined destination.

In an embodiment, the at least one memory is configured to store the user information in association with a folder, and the circuitry is further configured to detect to store the data in the folder in association with the user information; acquire the user information associated with the folder which is detected to store the data; compare the result of analyzing the character strings of signature included the data with the acquired user information in association with the folder which is detected to store the data.

In an embodiment, the circuitry is further configured to permit access the folder associated with the user information, when accessed by a user which is indicated in the user information.

In an embodiment, the folder includes a shared folder, and the user information is a folder name of the folder.

In an embodiment, the at least one memory is configured to store the user information in association with device information which indicates the user who performs access to the information processing apparatus; and the circuitry is further configured to acquire the user information associated with the user who performs access to the information processing apparatus; and compare result of analyzing the character strings of signature included the data with the acquired user information associated with the device information indicating the user who performs access to the information processing apparatus.

In an embodiment, an information processing system is provided, comprising: at least one memory; and circuitry configured to; acquire user information; receive data that includes a signature; analyze character strings of the signature included in the data; compare a result of analyzing the character strings of the signature included the data with the acquired user information; and in response to the result of comparing the character strings of the signature included in the data with the acquired user information, send the data to a predetermined destination.

In an embodiment, an information processing method is provided, performed by circuitry of an information processing apparatus, comprising: acquiring user information; receiving data that includes a signature; analyzing character strings of the signature included in the data; comparing a result of analyzing the character strings of the signature included in the data with the acquired user information; and in response to the result of comparing the character strings of the signature included in the data with the acquired user information, sending the data to a predetermined destination.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an exemplary apparatus configuration of an information processing system according to an embodiment of the present invention.

FIG. 2 is a block diagram illustrating an exemplary hardware configuration of a document management server and a smart device 20 according to an embodiment of the present invention.

FIG. 3 is a block diagram illustrating an exemplary functional configuration of the document management server according to an embodiment of the present invention.

FIG. 4 is a block diagram illustrating an exemplary functional configuration of a smart device according to an embodiment of the present invention.

FIG. 5 is a block diagram illustrating an exemplary configuration of folder being published by the document management server according to an embodiment of the present invention.

FIGS. 6A, 6B, and 6C are explanatory diagrams illustrating association between the document management server and the smart device according to an embodiment of the present invention.

FIG. 7 is a sequence diagram illustrating an exemplary a voucher storing process of the document management server according to an embodiment of the present invention.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In the following, embodiments are described with reference to the accompanying drawings.

### <Configuration of Information Processing System>

At first, Configuration of information processing system of this embodiment is described.

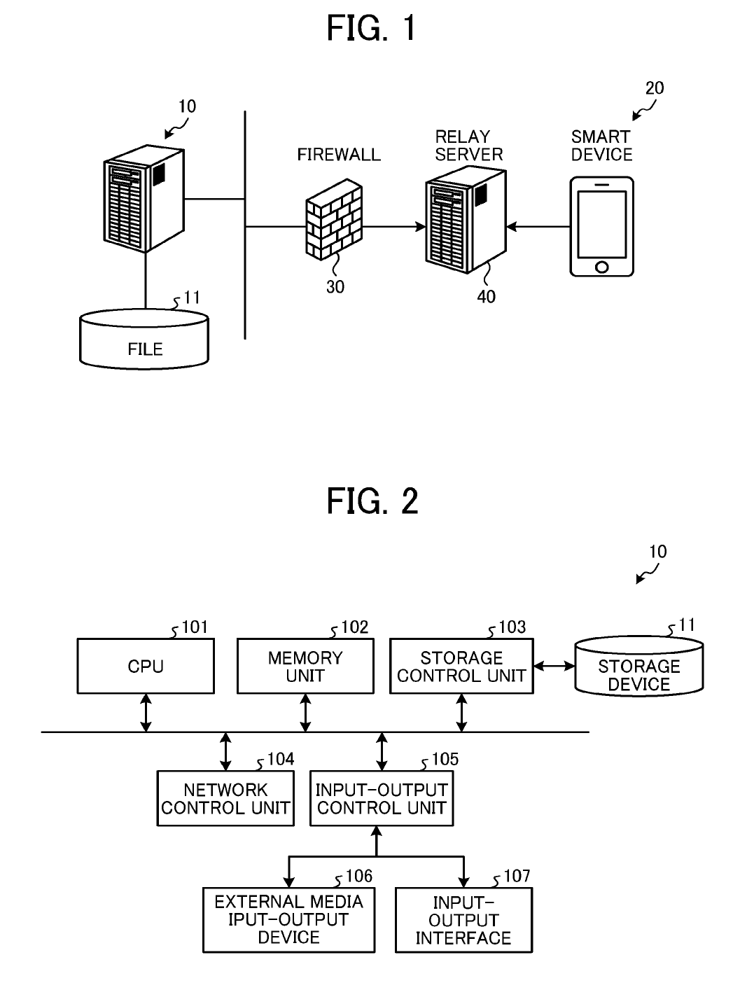

FIG. 1 is a diagram illustrating an exemplary apparatus configuration of an information processing system according to an embodiment. As illustrated in FIG. 1, in the information processing system, a document management server 10, functioning as an information processing apparatus, communicates with a smart device 20, functioning as an information terminal device, via a firewall 30 and a relay server 40. The document management server has a storage device 11 that manages a plurality of files. The relay server 40 is on a cloud system. The smart device 20 is used by a user. The smart device has a device information corresponding to the user. The smart device may be called a smart phone, a mobile terminal, a mobile phone, a personal computer, a tablet device, and the like. The document server 10 is not limited to being in an on-premises environment, and it may be in a cloud environment. In this case, the relay server is not necessary.

### <Hardware Configuration of Document Management Server>

FIG. 2 is a block diagram illustrating an exemplary hardware configuration of the document management server 10 and the smart device 20 according to an embodiment. In FIG. 2, a CPU 101 performs control of each device, calculation and data processing. A CPU 101 is calculation device that executes a program stored in a memory unit 102. The CPU 101 receives a data from an input device or a storage device, calculates the data, converts the data, and then outputs the data to an output device or the storage device. Furthermore, each unit described below is connected by an internal bus.

A memory unit 102 is a storage device such as a read-only memory (ROM) or a random access memory (RAM). The memory unit 102 stores or temporally stores programs and data such as an OS and an application software which are basic software executed by the document management server 10.

A storage device control unit 103 is a storage device such as an HDD, and stores data related to application software and so on. The storage device control unit also stores various information managed by the document management server 10 (for example, user information). The various data is managed by a database or a file system or the like.

A network control unit 104 is an Ethernet (registered trademark) controller or the like. The network control unit 104 has a function for communicating with another computer using a local area network (LAN) or a wide area network (WAN).

The input-output device control unit 105 manages an external media input-output device 106 and an input-output interface 107. The input-output device control unit 105 is input from an external device, and output to an external device.

An external media input-output device 106 inputs/outputs data by controlling an external media such as a USB storage medium, a compact flash (CF) card, and a secure digital (SD) card.

An input-output interface 107 is an interface for connecting the external device such as a serial port, USB port, IEEE1934 port and the like. The document management server can use more general input-output devices by having various input-output interfaces 107.

### <Function Configuration of Document Management Server>

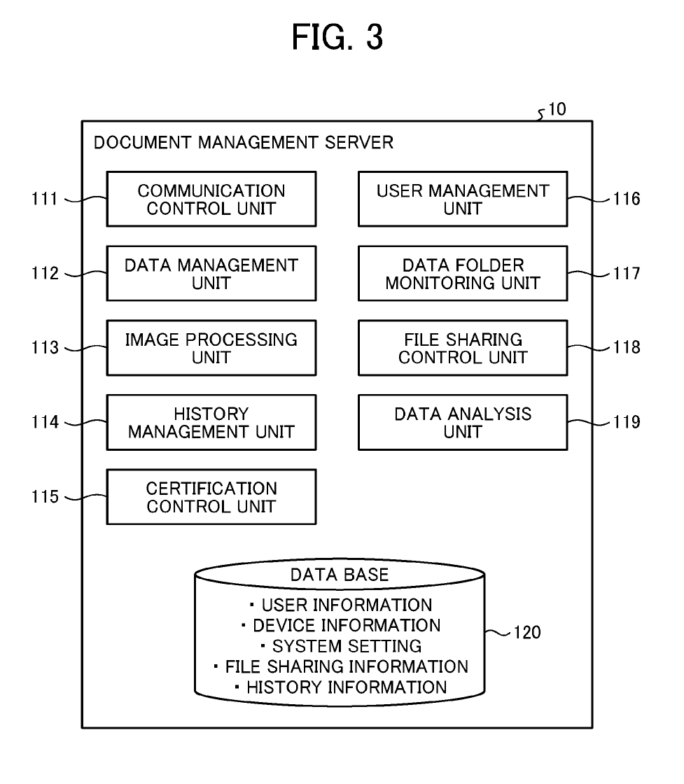

FIG. 3 is a block diagram illustrating an exemplary functional configuration of the document management server according to an embodiment. In FIG. 3, the document management server 10 includes a communication control unit 111, a data management unit 112, an image processing unit 113, a history management unit 114, a certification control unit 115, a user management unit 116, a data file monitoring unit 117, a file sharing control unit 118, a data analysis unit 119, and a database 120. These functions of the document server 10 are executed in cooperation with instructions of the CPU 101 according to the program expanded from the storage control unit 103 such as the HDD to the memory unit 102 such as the RAM.

The communication control unit 111 transmits and receives various requests (information provision, information acquisition, various notification, and so on) from the information terminal device such as the smart device 20.

The data management unit 112 manages data stored in the document management server 10.

The image processing unit 113 performs an image process (format conversion and Optical Character Recognition-called OCR) of a file stored in the document management server 10. In OCR, the image processing unit 113 can process only specific areas. In the present embodiment, the image process of file is described as an OCR process. Furthermore, the image processing unit 113 functions as an analysis unit.

The history management unit 114 records processes and accesses which occur in the document management server 10.

A certification control unit 115 controls access authority to the document management server 10.

A user management unit 116 manages users accessible to the document management server.

A data file monitoring unit 117 monitors a folder shared by the document management server 10, and requests process of a file stored in specific folder.

A file sharing control unit 118 controls the shared folder published to another device.

The data analysis unit 119 analyzes imported data and compares data. The data analysis unit 119 functions as a comparison unit.

The database 120 controls storing user information, device information, system setting values, file sharing information, and history information.

### <Function Configuration of Smart Device>

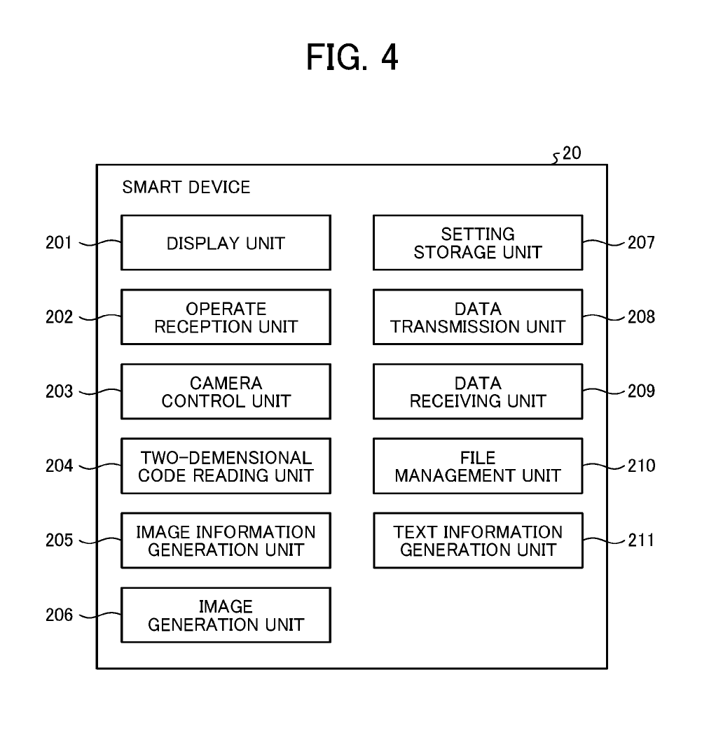

FIG. 4 is a block diagram illustrating an exemplary functional configuration of a smart device according to an embodiment. In FIG. 4, the smart device 20 includes a display unit 201, an operation reception unit 202, a camera control unit 203, a two-dimensional code reading unit 204, an image information generation unit 205, an image generation unit 206, a setting storage unit 207, a data transmission unit 208, a data reception unit 209, a file management unit 210, and a text information generation unit 211. These functions of the smart device 20 are executed that are implemented in cooperation with instructions of the CPU 101 according to the program expanded from the storage control unit 103 such as the HDD to the memory unit 102 such as the RAM.

The display unit 201 controls display of contents of a file, a chat message, a file selection screen, and the like on a display device.

The operation reception unit 202 receives a user operation via a screen.

The camera control unit 203 controls activation of a camera.

The two-dimensional code reading unit 204 reads a two-dimensional code.

The image information generation unit 205 generates image information such as file names and the area of image selected by user operation. The area is included in an image of file displayed by the display unit 201.

The image generation unit 206 generates an image from the image information.

The setting storage unit 207 controls storage of settings such as a user name, a password, a group and the like.

The data transmission unit 208 controls transmission of the chat message, the image information, and the like.

A data reception unit 209 controls reception of the chat message, the image information, files, and the like.

The file management unit 210 controls storage and deletion of a cache of received files.

The text information generation unit 211 generates image information such as an area of a character string selected by the user via the screen, and a file name. The area of a character string is included in a file image displayed by the display unit 201.

### <Folder Configuration of Document Management Server>

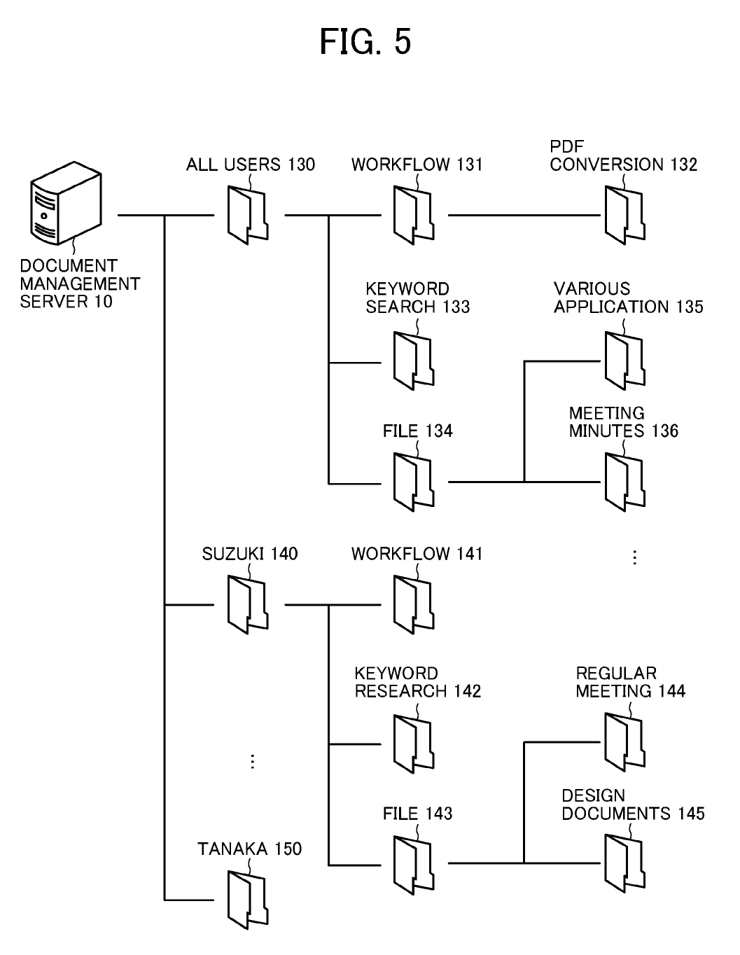

FIG. 5 is a block diagram illustrating an exemplary configuration of folder being published by the document management server according to an embodiment. In FIG. 5, any device of user who is registered in the document management server 10 can perform access under the “AllUsers” folder.

In a user folder (suzuki, tanaka, and so on), the folder name is a user ID registered in document management server 10. Only the device of the user corresponding to the user ID by the document management server 10 can access the user folder. For example, if the user folder name is “suzuki”, the user folder can be accessed only when logging in to the document management server 10 with the account of “suzuki”.

When a file is stored under a “workflow” folder, the document management server 10 performs a predetermined process to the file. The predetermined process is set to the folder by using a management tool of the document manage server 10 in advance. The management tool provides a Web user interface to the device of user such as the smart device 20. A “PDF conversion” folder is used for converting from a file stored in the “PDF conversion” folder to a PDF file. Convertible formats are PDF, PDF and OCR, image file, and the like. After conversion, the file is output to the shared folder in the document management server 10. The conversation notification includes notification by email, chat message, and the like.

When a file is stored under a “keyword search” folder, a shortcut of a document including a keyword is created in the shared folder in document management server. The keyword is the name of folder in the “keyword search” folder. For example, if a folder named “MFP” is created in the “keyword search” folder, the document including the word “MFP” is searched from files in the “AllUsers” folder.

Files are stored in a “file” folder.

<Association between Document Management Server and Smart Device>

The document management server performs process below, in order to associate the smart device 20 used by a user and a user information registered in the document management server 10.

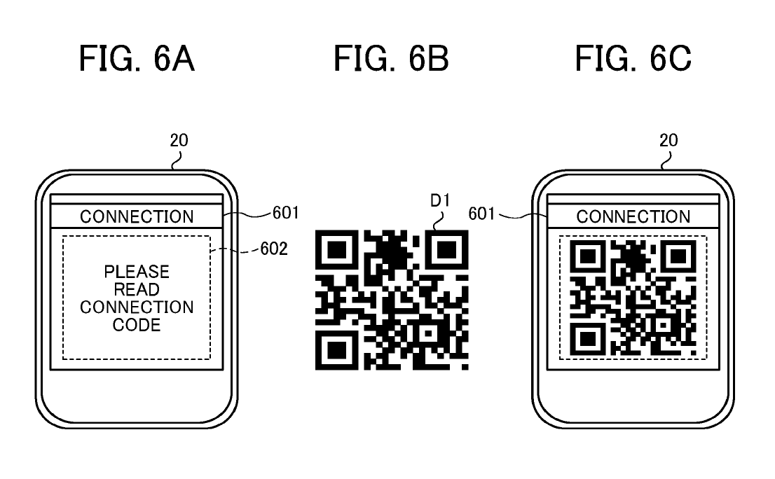

First, an information terminal, such as a PC, displays a Web interface of the document management server 10. When logging in the document management server 10 by using a user account registered in the document management server 10, a two-dimensional code for associating a device and the document management server 10 is displayed in the Web interface (see FIG. 6(b)). Thereafter, the smart device 20 activates a client application, and receives an input of “connection” via a screen of the client application. Then, the camera is activated (see FIG. 6(a)). Thereafter, the smart device 20 reads the two-dimensional code shown in FIG. 6(b) by using the camera (see FIG. 6(c)). The client application of the smart device 20 transmits a read information to the document management server. The management document server 20 associates the logged in user and the smart device 20.

### <User Information Stored in Document Management Server>

Table 1 indicates an exemplary user information stored in the document management server 10 according to an embodiment of the present invention.

TABLE 1

| | | | | Device | | |
|---|---|---|---|---|---|---|
| | | | | usable/ | | |
| | | Device | | non- | | |
| User ID | User name | name | Device ID | usable | Mail address | shared folder |
| UserA | Satoh Taro | DeviceA-1 | ID: XXXXX_XXXX_XXXX_XXXX | ✓ | satoh@example.com | Satoh¥file¥receipt |
| | | DeviccA-2 | ID: XXXXX_XXXX_XXXX_XXXY | X | | Sotoh¥keyword_search |
| | | | | | | Satoh¥workflow¥SendReceipt |
| UserB | Tanaka | DeviceB-1 | ID: XXXXX_XXXX_XXXX_XXXZ | ✓ | tanaka@example.com | Tanaka¥file¥receipt |
| | Hajime | | | | | Tanaka¥keyword_search |
| | | | | | | Tanaka¥workflow¥SendReceipt |
| UserC | Itoh Makoto | DeviceC-1 | ID: XXXXX_XXXX_XXXX_XXXA | ✓ | itoh@example.com | Itoh¥file¥receipt |
| | | | | | | Itoh¥keyword_search |
| | | | | | | Itoh¥workflow¥SendReceipt |

The “User ID” in Table 1 is a user ID of a user registered in the document management server 10. The user ID is unique in the document management server 10. “Device name” is a name of the smart device. The “Device usable/non-usable” category indicates whether the user is permitted to use voucher registration. The “Mail address” indicates a mail address of the user. The “Shared folder” indicates a folder shared by the user.

### <User Information Stored in Document Management Server>

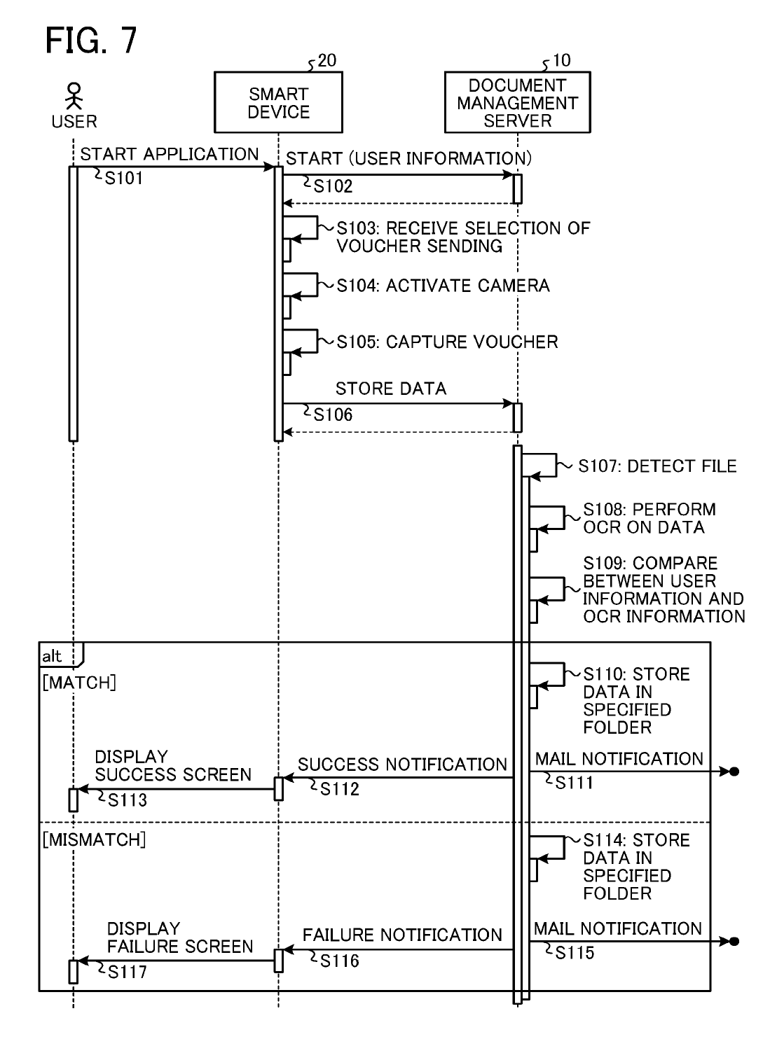

A data storing process in the document management server is described below. In the present embodiment, the smart device 20 transmits a voucher, which may be a tax filing document, to the document management server 10. The document management server stores the voucher. FIG. 7 is a sequence diagram illustrating an exemplary voucher storing process of the document management server according to an embodiment.

In FIG. 7, the smart device 20 activates the client application (step S101). After activating the client application, the smart device 20 receives an input of user information via the screen of the client application (step S102). Thereafter, the smart device 20 receives an input of “voucher transmission” via the screen (step S104). After that, the smart device 20 activates the camera (step S104). The smart device captures in image of the hard copy of voucher including a signature by using the activated camera (step S105), and transmits the captured image data of the voucher to the document management server 10 (step S106). The document management server 10 stores the captured image data of voucher in a “workflow” folder. By storing the captured image data of voucher in the “workflow” folder, the document management server performs a process to the captured image data of voucher.

The document management server 10 detects that data (a file) is stored in the “workflow” folder (step S107), and performs the OCR process to the data in response to the detection (step S108). The document management server compares user information of the “workflow” folder and signature information acquired by the OCR process (step S109). Furthermore, the date and time information and the folder name also can be compared to the result of the OCR process. For example, when the document management server 10 performs a comparison process by using date and time information, the document management server 10 can allow only the data of a voucher which is submitted within a submission deadline. In addition, the document management server 10 can compare signature information and the folder name. In this case, the folder name needs to be associated with the user information in advance.

When the user information matches the signature information, the document management server 10 stores the captured data of voucher in a folder for storing vouchers (step S110) Then, the document management server notifies a voucher system via e-mail of the success (step S111). Furthermore, the document management server 10 may send another system instead of storing the folder for storing vouchers. Thereafter, the document management server 10 notifies the smart device 20 of the success of the voucher process (step S112). The smart device 20 displays a success screen of the client application on display device (step S113).

In the present embodiment, the document management server 10 receives the document file including a signature, analyzes the document file by OCR process, identifies a character string of a handwritten signature included in the document file, and when the character string and user information match, transmits the document file to predetermined system or device, or stores the document file in predetermined area. Therefore, the system can easily identify a user of the document file including a signature by using a result of a character recognition process.

In addition, the user information in step S109 may be user information used for login, not user information of the folder. In this case, the document management server 10 acquires user information for login in step S109.

As described above, when the user device submits the document including a handwriting signature by using electronic process, a system does not have to perform handwriting analysis to identify the user from the handwriting signature. Therefore, it is not necessary to build a large scale system. Furthermore, the voucher document including a handwriting signature can be easily utilized. In other word, when the document management server 10 sorts the document file, including the signature, it is possible to easily associate the result of analysis of the signature and verify that a user signed the document, and to quickly sort the document file including signature.

The claimed invention is not limited to the above described embodiments and variations. The components can be modified and realized. In addition, combination of elements of the embodiments and the variations can form variations invention. For example, some constituent elements may be deleted from all the constituent elements illustrated in the embodiments and the variations. Any one of the above-described operations may be performed in variations other ways, for example, in an order different from the one described above.

The software (program) executed by the document server 10 and the smart device 20 according to the embodiments and the variations can be provided by a file in an installable format or an executable format that stored CD-ROM, a flexible disk (FD), CD-R, DVD (Digital Versatile Disk), USB (Universal Serial Bus). Furthermore, the file can be provided via a network such as the Internet. The software (program) also can be provided by being incorporated in a ROM in advance.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing system comprising;
at least one memory; and
circuitry configured to;
acquire user information;
receive data that includes a signature;
analyze character strings of the signature included in the data;
compare a result of analyzing the character strings of the signature included the data with the acquired user information; and
in response to the result of comparing the character strings of the signature included in the data with the acquired user information, send the data to a predetermined destination.

2. The information processing system of claim 1,
wherein the character strings are analyzed by optical character recognition.

3. The information processing system of claim 1, wherein
the circuitry is further configured to
when the result of comparing the character strings of the signature indicate that the result of analyzing the character strings of the signature which is included the data and the acquired user information match, determine to send the data to the predetermined destination.

4. The information processing system of claim 1, wherein
the at least one memory is configured to store the user information in association with a folder, and
the circuitry is further configured to
detect to store the data in the folder in association with the user information;
acquire the user information associated with the folder which is detected to store the data; and
compare the result of analyzing the character strings of signature included the data with the acquired user information in association with the folder which is detected to store the data.

5. The information processing system of claim 4,
wherein the circuitry is further configured to
permit access the folder associated with the user information, when accessed by a user which is indicated in the user information.

6. The information processing system of claim 4,
wherein the folder includes a shared folder, and
the user information is a folder name of the folder.

7. The information processing system of claim 1,
the at least one memory is configured to store the user information in association with device information which indicates the user who performs access to the information processing apparatus; and
the circuitry is further configured to
acquire the user information associated with the user who performs access to the information processing apparatus; and
compare result of analyzing the character strings of signature included the data with the acquired user information associated with the device information indicating the user who performs access to the information processing apparatus.

8. The information processing system according to claim 7,
wherein the device information corresponds to a mobile terminal of the user which transmitted the user information to the information processing system, and
the circuitry is configured to associate the mobile terminal with the user after the mobile terminal transmits information corresponding to the user.

9. The information processing system according to claim 8,
wherein the mobile terminal is configured to
activate an application for transmitting an image of a document to the information processing system;
in response to receiving an input from a user within the application to transmit the document to the information processing apparatus, activate an image capturing device of the user terminal;
capture, with the image capturing device, an image of a hard copy of the document; and
transmit the captured image of the hard copy of the document to the information processing system as the transmitted information.

10. The information processing system according to claim 8,
wherein the information that the mobile terminal transmits to the information processing system is initially embedded in a code that is displayed at separate user terminal for which the user is logged into an Internet page corresponding to the information processing system.

11. The information processing system according to claim 10,
wherein the mobile terminal is configured to:
after activating the application, and in response to receiving an input from the user within the application to establish a connection with the information processing system, activate the image capturing device;
read, with the image capturing device, the code displayed on the Internet page on the separate user terminal; and
transmit the read information to the information processing system.

12. An information processing method, performed by circuitry of an information processing system, comprising:
acquiring user information;
receiving data that includes a signature;
analyzing character strings of the signature included in the data;
comparing a result of analyzing the character strings of the signature included in the data with the acquired user information; and
in response to the result of comparing the character strings of the signature included in the data with the acquired user information, sending the data to a predetermined destination.

13. An information processing apparatus comprising;
circuitry configured to;
acquire user information;
receive data that includes a signature;
compare a result of analyzing the character strings of the signature included the data with the acquired user information; and
in response to the result of comparing the character strings of the signature included in the data with the acquired user information, send the data to a predetermined destination.
